(19) United States
(12) Patent Application Publication
(10) Pub. No.: US 2004/0118358 A1
(43) Pub. Date: Jun. 24, 2004

(54) Fertilizer made from absorbent animal bedding material and method of manufacturing same

(76) Inventor: James Stephen Davis, Wingate, NC (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/352,664

(22) Filed: Jan. 28, 2003

Related U.S. Application Data
(63) Continuation-in-part of application No. 10/323,066, filed on Dec. 18, 2002.

(51) Int. Cl. A01K 29/00

(52) U.S. Cl. 119/171

(57) ABSTRACT

A composition useful as an organic fertilizer that includes a mixture of ground drywall, wood, poultry manure, and used brooder litter. The ground drywall includes at least ground gypsum and ground paper backing. The mixture is cured for a period of time, screened, and then bagged for sale.

### CROSS-REFERENCE TO RELATED APPLICATIONS

This application is a continuation-in-part of pending U.S. application Ser. No. 10/323,066, filed on Dec. 18, 2002.

### FIELD OF THE INVENTION

The present invention relates to organic fertilizer and, more particularly to an organic fertilizer that is made from used animal bedding material that includes ground drywall as a constituent and that is used for animals such as, for example, chickens in poultry grow houses.

### BACKGROUND OF THE INVENTION

Animal bedding material is used in various environments to absorb animal waste. For example, many commercial poultry grow houses include bedding material on the grow house floor, to absorb the natural waste from the chickens, to thereby potentially enhance their health and growth. No matter the particular end use environment, the bedding material, in addition to being a relatively good waste product absorber, should preferably be relatively nonirritating to the animals that are exposed to the bedding material, as well.

In the past, many commercial poultry grow house bedding materials consisted of pine shavings and sawdust. However, in the recent past there has been an increase in the demand for, and a concomitant reduction in supply of, these materials. As a result, some commercial poultry growers have used alternative materials, such as kiln-dried hardwood, wood chips, rice and peanut hulls, chopped straw, shredded newspaper, and sand.

No matter the particular composition of the animal bedding material, after a number of uses by various numbers poultry, the used bedding material may be removed from the grow house and replaced with new bedding material. The used bedding material may be either thrown out as refuse or recycled. One of the recyclable uses of used bedding material is as an organic fertilizer.

Although the above-mentioned materials are generally safe and useful as organic fertilizers after use as bedding materials, each suffers certain drawbacks. For example, some of the materials can be relatively expensive. In addition, some of these materials are mixed with chemical additives to improve performance and/or reduce bacterial growth during use as a bedding material. These additives can be expensive and, in some instances, can reduce the effectiveness of the used bedding material as a fertilizer. Moreover, in some instances, the process used to convert the used bedding material into fertilizer can be complex, time consuming, and relatively expensive.

Hence, there is a need for an organic fertilizer material that improves on one or more of the drawbacks mentioned above. Namely, a fertilizer that can be made from used animal bedding material that is relatively inexpensive, and/or is not mixed with one or more chemical additives, and/or can be made using a fairly non-complex process. The present invention addresses one or more of these needs.

### SUMMARY OF THE INVENTION

The present invention provides an organic fertilizer material made from used bedding material that is relatively inexpensive, is not mixed with one or more chemical additives, and can be made using a fairly non-complex process.

In one embodiment, and by way of example only, a composition useful as an agricultural fertilizer is a mixture of used animal bedding material and substantially fresh ground drywall. The used animal bedding material includes at least ground drywall, wood, and poultry manure. The substantially fresh ground drywall includes at least ground gypsum and ground paper backing.

In another exemplary embodiment, a method of making fertilizer includes spreading fresh animal bedding material on a bedding surface in a poultry grow house. The fresh animal bedding material is exposed to a plurality of poultry for a period of time to create used animal bedding material. The used animal bedding material is cured for a time period to produce an organic fertilizer. The fresh animal bedding material includes a layer of substantially dry ground drywall that has a concentration of greater than 10 g/ft² and has at least ground gypsum and ground paper backing, and a layer of substantially absorbent litter material.

Other independent features and advantages of the preferred fertilizer will become apparent from the following detailed description, taken in conjunction with the accompanying drawings which illustrate, by way of example, the principles of the invention.

### BRIEF DESCRIPTION OF THE DRAWINGS

FIG. 1 is a simplified end view of an exemplary poultry grow house;

FIG. 2 is a cross section view of a bedding material according to an embodiment of the invention that may be used in the grow house of FIG. 1; and

FIG. 3 is a perspective view of an exemplary piece of drywall that may be used to make the bedding material of FIG. 2;

FIG. 4 is a process flow diagram showing the process that is used to make the fertilizer according to an embodiment of the present invention; and

FIG. 5 is a process flow diagram showing the curing portion of the process shown in FIG. 4 in more detail.

### DETAILED DESCRIPTION OF A PREFERRED EMBODIMENT

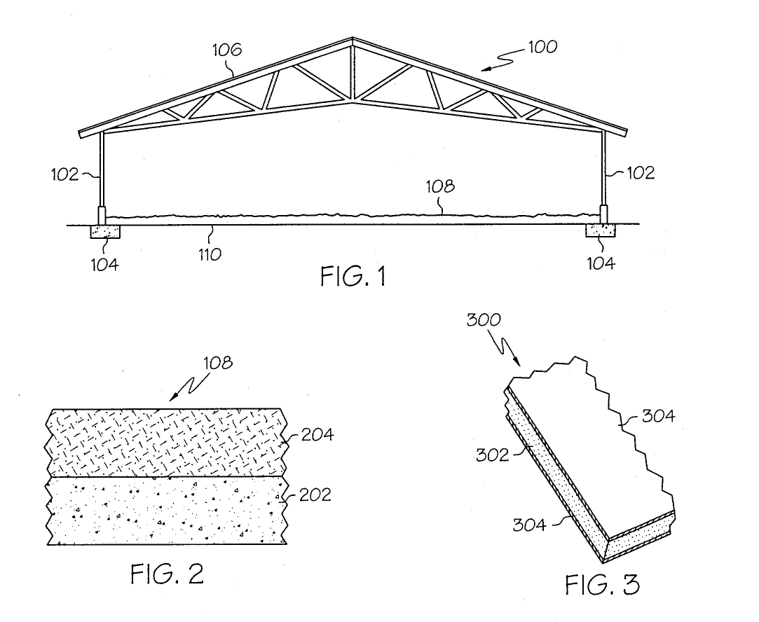

Many chickens that are bred and grown for commercial purposes are kept in poultry grow houses rather than, for example, wire cages. A simplified end view of an exemplary poultry grow house 100 is illustrated in FIG. 1, and includes at least two sidewalls 102 supported on a foundation 104, and a trussed roof 106 that is supported by the sidewalls 102. A bedding material 108 is spread onto various bedding surfaces such as, for example, a floor 110 of the grow house 100, in order to absorb the natural waste the chickens produce.

The bedding material 108, as shown more clearly in FIG. 2, includes at least a layer of ground drywall 202 and a layer of an absorbent litter material 204. The ground drywall 202 is preferably made by grinding or comminuting either scrap, or new, pieces or sheets of drywall. An exemplary piece of drywall 300, before it has been ground, is shown in FIG. 3. The drywall 300 is constructed of a core material 302 disposed between, or completely enveloped by, a paper backing 304. The core material 302 is preferably composed substantially of gypsum, though other constituent elements could be present. To grind the drywall 300, the drywall pieces or sheets, with the paper backing 304 still on, are placed in any one of numerous grinding machines. Thus, the ground drywall 202 includes both the gypsum 302 and the paper backing 304. In a particular preferred embodiment, the drywall 300 is coarsely ground in a tub grinder using a ¾-inch screen. The tub grinder is preferably positioned under a dust-collector to minimize the spread of dust during the grinding process. Although, in the preferred embodiment, the drywall is coarsely ground, it will be appreciated that the drywall could be ground finer.

The absorbent litter material 204 that is used in combination with the ground drywall 202 may be any one of numerous animal litter materials known now, or in the future, including, but not limited to, kiln-dried hardwood, wood chips, wood shavings, rice hulls, peanut hulls, chopped straw, shredded newspaper, and sand. In a preferred embodiment, however, the litter material is sawdust. The sawdust may come from any one of numerous types of wood, but in a preferred embodiment, the sawdust is pine sawdust.

Returning once again to FIGS. 1 and 2, the bedding material 108 is placed on the grow house floor 110 by first spreading an approximately 2-inch layer of the ground drywall 202, and then spreading an approximately 2-inch layer of the absorbent litter material 204 over the ground drywall 202. The spreading of either, or both, the ground drywall 202 and the litter material 204, may be done using, for example, a spreader truck. It is to be appreciated that the thickness of the ground drywall 202 and litter material 204 layers could be more or less than 2-inches, and that these thicknesses are merely exemplary of a particular preferred embodiment. However, the ground drywall 202 layer should be of sufficient thickness to provide more than just a dusting of the bedding surfaces, such as would be expected if it were applied at a concentration of 10 g/ft², or less. Moreover, in the preferred embodiment, the ground drywall 202 is approximately 50%, by volume, of the total bedding in the grow house 100, though it is not limited to this volume percent.

It will additionally be appreciated that the layer of absorbent litter material 204 could be spread first, followed by the layer of ground drywall 202. However, spreading the ground drywall 202 first reduces the amount of drywall dust that is released when the bedding material 108 is spread in the grow house 100. Further, although the layer of litter material 204 is preferably overlaid directly on top of the layer of ground drywall 202, this configuration is not necessary. Rather, an additional layer of another type of absorbent material could be placed between the layer of ground drywall 202 and the layer of litter material 204.

In the embodiment depicted in FIGS. 1 and 2, when the bedding material 108 is first placed in the grow house 100, it is not blended together as a mixture. However, after the chickens are introduced into the grow house 100 and onto the bedding material 108, the ground drywall 202 and litter material 204 layers will begin blending together. After a while, the chickens will have blended the two layers together into a substantially homogeneous mixture. It will be appreciated that the ground drywall 202 and the litter material 204 could be pre-blended into a substantially homogeneous mixture, and then spread on the grow house bedding surfaces. With this alternative embodiment, the ground drywall 202 is preferably approximately 50%, by volume, of the bedding material 108, and the bedding material 108 is preferably spread to a thickness of approximately 4-inches. Again, it is to be appreciated that this thickness is merely exemplary of a preferred embodiment, and that other thicknesses could be used.

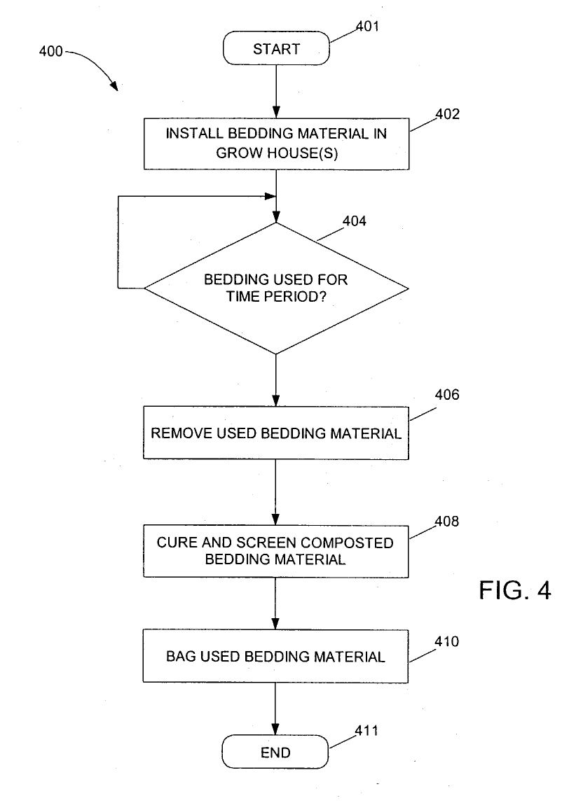

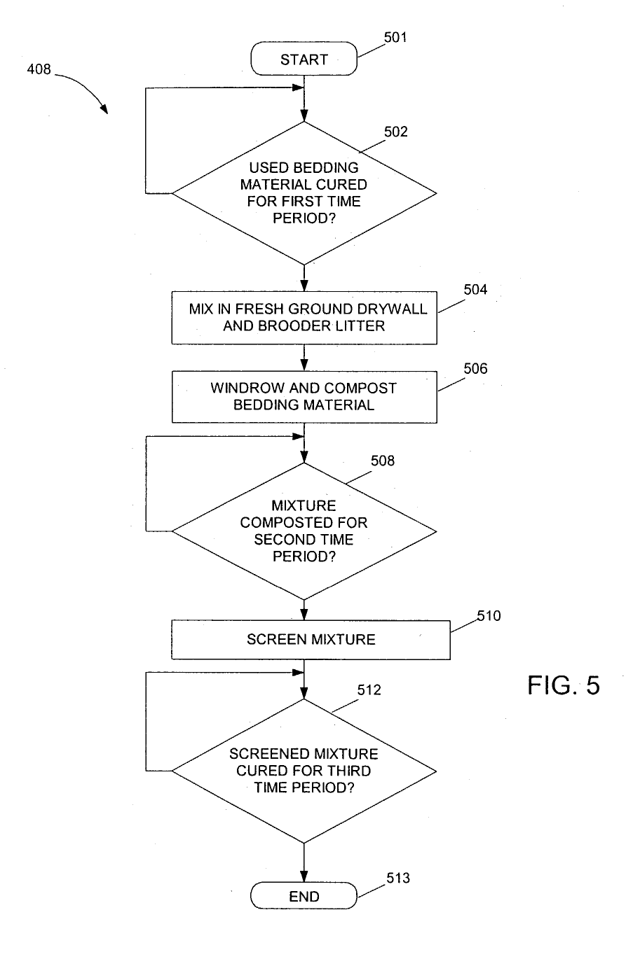

Having described the preferred bedding material 108, the process for making an organic fertilizer that uses the preferred bedding material will now be described. In doing so, reference should be made to FIGS. 4 and 5, in combination with FIGS. 1-3, as necessary. It should be understood that the parenthetical references in the following description refer to the labeled process flow diagram blocks in FIGS. 4 and 5.

Initially, the bedding material 108 is installed in one or more grow houses 110, as described above (402). The bedding material 108 remains in the grow house 100 for a period of time, during which several poultry flocks are grown on the bedding material in the grow house 100 (404). In a preferred embodiment, the bedding material 108 remains in the grow house for approximately nine to twelve months, during which multiple poultry flocks are grown on the bedding. It will be appreciated, however, that this time period and flock number is merely exemplary of a particular preferred embodiment, and that other time periods and flock numbers may be utilized.

After the above-described usage time period, the used bedding material is removed from the grow house 100 (406) and is cured (408). As part of the curing process (408), which is shown in more detail in FIG. 5, the used bedding material cured for a time period (502). In a preferred embodiment, during this curing time period the used bedding material is placed in a pyramid pile that is approximately 25 feet high, and is left undisturbed for approximately 4 to 6 months. It should be appreciated that the particular dimensions and type of pile may vary, and that the curing time period may be more or less than 4 to 6 months.

After the curing time period (502), additional materials are preferably (though not necessarily) mixed in with the bedding material to produce a bedding material mixture (504). In a particular preferred embodiment, the bedding material is mixed with fresh ground drywall and additional litter material, in a ratio of 1:1:1 by volume to produce a bedding material mixture. The fresh ground drywall is ground drywall that has not been used as an animal bedding material and, similar to the ground drywall 202 described above, includes both gypsum 302 and paper backing 304. The additional litter material is preferably used brooder litter, which is bedding material that has been used in brooder houses, and is primarily made up of sawdust or pin shavings. It will be appreciated that various other litter materials could be used instead of brooder litter.

The bedding material mixture is then composted for a time period (508). During the composting time period (508), the bedding material mixture is preferably windrowed (508), which aerates the used bedding mixture. Aerating the bedding material mixture decreases the time required to decompose the absorbed poultry waste, and turn the mixture into rich compost. The turning of the windrows may be performed manually, or with a compost turning machine. It should be appreciated that the turning of the windrows is merely exemplary of a preferred embodiment, and that this part of the curing process 408 may be skipped.

The composting time period (508) is preferably 4 to 6 weeks, though it will be appreciated that this time period may vary. Thereafter, the bedding material mixture is screened (510) to remove any constituent pieces of undesired material or debris. In a preferred embodiment, the mixture is put through a shaker-type screening machine, using screens having approximately ⅜-inch openings. It will be appreciated that the particular screening method and screen opening size could be varied.

After the mixture is screened, it is then cured for a second curing time period (512). During the second curing time period (512), the mixture is preferably stored, undisturbed, in a covered storage facility. The second curing time period (510) may also vary, but in a preferred embodiment it is approximately 4 weeks. Once the curing process (408) is complete, the used bedding material has been transformed into an organic fertilizer according to a preferred embodiment. Thereafter, the fertilizer is bagged for sale (410).

The above-described process 400 for manufacturing organic fertilizer from an animal bedding material 108 provides a fertilizer with an N—P—K (Nitrogent-Phosphorus-Potassium) value that is at least approximately 6-4-4. The bedding material 108 that is used to make the fertilizer includes ground drywall 202 as a constituent, and is therefore relatively inexpensive and provides a utility for scrap drywall, which might otherwise go to waste.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

I claim:

1. A composition useful as an agricultural fertilizer, comprising a mixture of:
used animal bedding material, the used animal bedding material including at least ground drywall, wood, and poultry manure; and
substantially fresh ground drywall, the substantially fresh ground drywall including at least ground gypsum and ground paper backing.

2. The composition of claim 1, further comprising:
used brooder litter, the used brooder litter including at least wood and poultry manure from one or more brooder grow houses.

3. The composition of claim 1, wherein the mixture is cured.

4. The composition of claim 3, wherein the mixture is windrowed during at least a portion of time that the mixture is cured.

5. The composition of claim 1, wherein the mixture has an N—P—K value of at least approximately 6-4-4.

6. The composition of claim 1, wherein the mixture is screened.

7. A method of making fertilizer, comprising:
spreading fresh animal bedding material on a bedding surface in a poultry grow house;
exposing the fresh animal bedding material to a plurality of poultry for a period of time to create used animal bedding material; and
curing the used animal bedding material to produce an organic fertilizer,
wherein the fresh animal bedding material comprises:
a layer of substantially fresh ground drywall having a concentration of greater than 10 g/ft² and including at least ground gypsum and ground paper backing, and
a layer of substantially absorbent litter material.

8. The method of claim 7, further comprising:
mixing the used animal bedding material with at least substantially fresh ground drywall that includes at least ground gypsum and ground paper backing.

9. The method of claim 8, further comprising:
mixing the used animal bedding material with brooder litter that includes at least wood and poultry manure from one or more brooder grow houses.

10. The method of claim 7, wherein the organic fertilizer has an N—P—K value of at least approximately 6-4-4.

11. The method of claim 7, wherein the used animal bedding material is windrowed during at least a portion of time that the used animal bedding material is cured.

12. The method of claim 7, further comprising:
screening the organic fertilizer.

13. A composition useful as an agricultural fertilizer, comprising:
a mixture of animal bedding material and poultry manure that has been cured for a time period,
wherein the animal bedding material comprises:
ground drywall including at least ground gypsum and ground paper backing, and
a substantially absorbent litter material.

14. The composition of claim 13, further comprising:
used brooder litter, the used brooder litter including at least wood and poultry manure from one or more brooder grow houses.

15. The composition of claim 13, wherein the mixture is cured.

16. The composition of claim 15, wherein the mixture is windrowed during at least a portion of time that the mixture is cured.

17. The composition of claim 1, wherein the mixture has an N—P—K value of at least approximately 6-4-4.

18. The composition of claim 1, wherein the mixture is screened.
